(19) United States
(12) Patent Application Publication
(10) Pub. No.: US 2014/0236488 A1
(43) Pub. Date: Aug. 21, 2014

(54) Computed Tomography Calibration Systems and Methods

(71) Applicant: Mindways Software, Inc., (US)

(72) Inventor: J. Keenan Brown, Austin, TX (US)

(73) Assignee: Mindways Software, Inc., Austin, TX (US)

(21) Appl. No.: 13/770,617

(22) Filed: Feb. 19, 2013

(51) Int. Cl. G01N 23/20

(52) U.S. Cl. CPC G01N 23/20075
USPC 702/19

(57) ABSTRACT

According to certain embodiments of the invention, computer hardware and software can perform single or dual-energy decomposition calculations and predict CT values for either single-energy or dual energy CT from basis material decomposition estimates derived using theoretical models. Using that information, the computer hardware and software can (among other things) present one dimensional information from a CT scanner, such as representative pixel value, in two dimensions, such as a line in two dimensional basis material space.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH AND DEVELOPMENT

NOT APPLICABLE

### FIELD OF THE INVENTION

This disclosure relates generally to computer hardware and software for calibrating single or multiple energy computed tomography (CT) devices. The hardware and software runs, displays, provides and otherwise uses electronic content; more particularly, such hardware and software operate on certain content that is independent of the CT scanner being used, in order (among other things) to calibrate the scanner and to present one dimensional information the CT scanner generates (such as representative pixel values) in two dimensional basis material space.

### BACKGROUND OF THE INVENTION

Quantitative Computed Tomography (QCT) is an established method for assessing bone, for example, bone mineral density. In principle other tissue types or traits are amenable to characterization with QCT; although, presently non-bone applications of QCT have not evolved to common clinical use.

Historically QCT bone densitometry has relied upon calibration of a CT image relative to a calibration standard with bone mineral density expressed in density units relative to the selected standard. While internal standards are sometimes used, such as calibration relative to fat and muscle attenuation as measured within a subject, the use of a standard external to a subject with well-known and stable x-ray attenuation properties generally provides advantages in terms of long-term measurement accuracy and precision. Most published descriptions of external calibration standards for bone densitometry involve the use of bone-mimicking standards. Regardless of the details, most calibration methods used for QCT rely upon standardizing QCT measurements to a one-dimensional scale.

Limitations of using a one-dimensional scale for reporting bone mineral density are known. Those include effect on such use of variations in marrow composition, as to which the impact of marrow composition on bone mineral density estimates have been explored. Dual energy QCT (DEQCT) has been used to characterize marrow-fat content and to quantify bias in bone mineral density estimates induced by marrow fat.

In this vein, the physical density of fat/yellow marrow (YM) and red marrow (RM) are different. The apparent bone marrow density of red marrow is approximately 50 mg/cm3 higher than the bone marrow density of yellow marrow. Since cancellous bone is composed mostly of marrow (>80%), change in marrow composition may confound true change in trabecular bone density if they are not distinguished. Additionally, chemotherapy and radiation cause marrow damage in vitro and in vivo. Although the concept of DEQCT to estimate bone mineral density corrected for marrow change was proposed earlier, DEQCT has not generally been translated to the study of osteoporosis in clinical practice.

### BRIEF SUMMARY OF THE INVENTION

The basis material decomposition theory published by Alvarez and Macovski provides an elegant framework for describing and understanding DEQCT. (R. Alvarez, A. Macovski, “Energy-selective reconstructions in x-ray computerised tomography,” Physics in Medicine and Biology 21, 733-744 (1976); L. Lehmann, R. Alvarez, A. Macovski, W. Brody, N. Pelc, S. Riederer, A. Hall, “Generalized image combinations in dual KVP digital radiography,” Medical Physics 8, 659 (1981), both of which are incorporated herein by this reference.) Applicability of this theory is predicated upon a set of assumptions regarding x-ray attenuation properties of material being imaged at two different x-ray energies. Of particular importance is that the materials being imaged must not have K-edges in or slightly below the x-ray energy windows used for imaging. This assumption is generally reasonably satisfied in the diagnostic x-ray energy regime for a broad range of substances including biological tissues. Dual energy x-ray absorptiometry, DXA, is perhaps the most successful conventional demonstration of the applicability of the basis material decomposition to the interpretation of x-ray images acquired at different energies.

The diagnostic x-ray energy regime is also interesting in that theoretical models and tabulated x-ray data can be used to predict mass attenuation coefficients for tissues of biological interest with accuracies on the order of 1% to 2%. Energy-dependent mass attenuation coefficients can be used to derive basis material decompositions that are analogous to those measured with dual-energy x-ray methods.

According to certain embodiments of the invention, computer hardware and software can perform single or dual-energy decomposition calculations and predict CT values for either single-energy or dual energy CT from basis material decomposition estimates derived using theoretical models. Using that information, the computer hardware and software can present one dimensional information from a CT scanner, such as representative pixel value for an unknown material, in two dimensions, such as a line in two dimensional basis material space. In some embodiments, for example, the hardware and software can predict CT values for heterogeneous mixtures of multiple tissue types, such as a model of bone including collagen, bone mineral described as calcium hydroxyapatite, and a mixture of red and yellow marrow, based on atomic compositions for the tissue types. In some embodiments, the hardware and software can interpret and present observed CT values from a single energy CT scan in a basis material space relative to the model tissue constituents; for example, a representative pixel value acquired from a CT scan can be presented in two dimensional basis material space with attendant new benefits for CT calibration. As another example, pixel values from a dual energy CT scan can be presented as lines in basis material space, whose intersection gives information about the basis material composition of the scanned material.

According to some embodiments, a method is executed by a computing device that includes these steps:

1. For a reference material and for each of a first basis material and a second basis material, receiving an energy-dependent, mass attenuation coefficient for the material as a function of its elemental composition, molecular composition or elemental and molecular composition;
2. Deriving a basis material composition of the reference material relative to the first basis material and the second basis material;
3. Characterizing the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets;
4. From imaging information related to an unknown material received from the CT scanner at the first energy level; extracting at least one unknown material CT pixel value representative of a predetermined region of the unknown material; and presenting the at least one unknown material CT pixel value as a function of the characterization of the response of the CT scanner to the reference material relative to the first basis material and the second basis material.

Some embodiments relate to a system that includes a processor device and a tangible medium embodiment code. The code can be executable by the processor to cause the system to perform certain actions. The actions can include:

1. For a reference material and for each of a first basis material and a second basis material, receiving an energy-dependent, mass attenuation coefficient for the material as a function of its elemental composition, molecular composition or elemental and molecular composition;
2. Deriving a basis material composition of the reference material relative to the first basis material and the second basis material;
3. Characterizing the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets;
4. From imaging information related to an unknown material received from the CT scanner at the first energy level; extracting at least one unknown material CT pixel value representative of a predetermined region of the unknown material; and presenting the at least one unknown material CT pixel value as a function of the characterization of the response of the CT scanner to the reference material relative to the first basis material and the second basis material.

Some embodiments relate to a tangible computer readable medium that includes program code that is executable by a processor to perform actions. The program code includes code for causing the processor to carry out the following method:

1. For a reference material and for each of a first basis material and a second basis material, receiving an energy-dependent, mass attenuation coefficient for the material as a function of its elemental composition, molecular composition or elemental and molecular composition;
2. Deriving a basis material composition of the reference material relative to the first basis material and the second basis material;
3. Characterizing the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets;
4. From imaging information related to an unknown material received from the CT scanner at the first energy level; extracting at least one unknown material CT pixel value representative of a predetermined region of the unknown material; and presenting the at least one unknown material CT pixel value as a function of the characterization of the response of the CT scanner to the reference material relative to the first basis material and the second basis material.

In some embodiments, the computer devices, processor devices, tangible medium embodiment code, and tangible computer readable medium that includes program code can perform any or all of the following actions:

Using one or more CT pixel values to present an unknown material line in two dimensional basis material space, in order to characterize the unknown material.

Mapping the characterization of the response of the CT scanner to the first basis material and the second basis material to a single dimensional value relating to the reference material.

Mapping the representation of the unknown material CT pixel values as a function of the characterization of the response of the CT scanner to the first basis material and the second basis material to a single dimensional value relating to the reference material.

Comparing an unknown material line in two dimensional basis material space to a line for the reference material in two dimensional basis material space in order further to characterize the unknown material.

Receiving imaging information, carrying out methods described above, and presenting information for the unknown material at a first energy level and a second energy level.

Mapping the at least one unknown material CT pixel value back to a family of possible basis material compositions that are predicted to exhibit the same CT pixel value as the at least one unknown material CT pixel value.

Receiving imaging information for the unknown material can include receiving imaging information for a tissue, mixture, or substance.

Characterizing unknown material selected from the group consisting of: pancreatic tissue, bone marrow tissue, brain tissue, fat in muscle tissue, heart tissue, soft tissue, non-bone tissue, lung tissue, kidney stones, kidney tissue, and iron in liver tissue.

Distinguishing tissue, or portions of tissue from other portions of tissue, the tissue selected from the group consisting of: fat in pancreatic tissue, red and yellow bone marrow tissue, white and grey matter brain tissue, fat in muscle tissue, healthy and necrotic heart tissue, healthy and nectrotic soft tissue, healthy and diseased non-bone tissue, normal and diseased lung tissue, kidney stones in kidney tissue, and iron in liver tissue.

In some embodiments, processes in step 3 in the embodiments stated above can occur at a time (and/or on a CT scanner) different than step 4 in those embodiments; thus, some or all of step 3, that is, characterizing the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets can occur at a time (or on a CT scanner) different from some or all of step 4, that is from imaging information related to an unknown material received from the CT scanner at the first energy level; extracting at least one unknown material CT pixel value representative of a predetermined region of the unknown material; and presenting the at least one unknown material CT pixel value as a function of the characterization of the response of the CT scanner to the reference material relative to the first basis material and the second basis material.

### BRIEF DESCRIPTION OF THE DRAWINGS

FIG. 1 is a functional block diagram of a system that is capable of carrying out methods according to certain embodiments of the invention.

FIG. 2 is a flow diagram showing process flow for one method according to an embodiment of the invention.

FIG. 3 is a diagram that shows a first presentation according to an embodiment of the invention.

FIG. 4 is a diagram that shows a second presentation according to an embodiment of the invention.

FIG. 5 is a diagram that shows a third presentation according to an embodiment of the invention.

FIG. 6 is a diagram that shows a fourth presentation according to an embodiment of the invention.

FIG. 7 is a diagram that shows a fifth presentation according to an embodiment of the invention.

FIG. 8 is a graph showing pairs of MRS and DEQCT fat measurements.

FIG. 9 is a graph showing changes in a fat signal as measured by both MRS and DEQCT methods.

### DETAILED DESCRIPTION OF THE INVENTION

a. Illustrative System Implementation

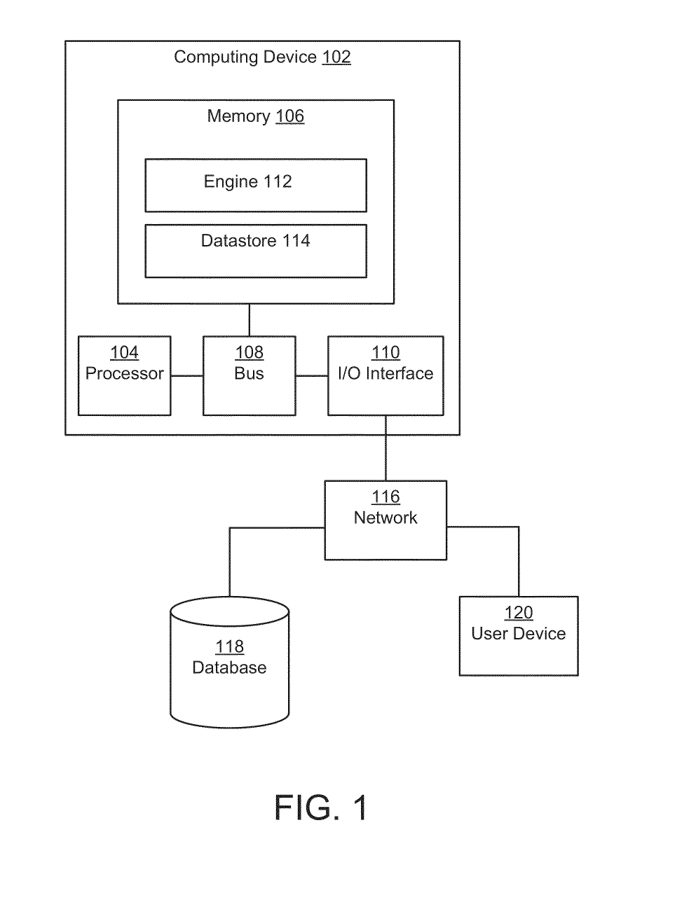

FIG. 1 depicts a system that is configured, according to certain embodiments of the invention, to do any or all of at least the following: Perform single or dual-energy decomposition calculations and predict CT values for either single-energy or dual energy CT from basis material decomposition estimates derived using theoretical models; present one dimensional information from a CT scanner, such as representative pixel value for an unknown material, in two dimensions, such as a line in two dimensional basis material space; predict CT values for heterogeneous mixtures of multiple tissue types, such as a model of bone including collagen, bone mineral described as calcium hydroxyapatite, and a mixture of red and yellow marrow, based on atomic compositions for the tissue types; present observed CT values from a single energy CT scan in a basis material space relative to the model tissue constituents, such as, for example, presenting a representative pixel value acquired from a CT scan in two dimensional basis material space; present, based on pixel values from a dual energy CT scan, lines in basis material space, whose intersection gives information about the basis material composition of the scanned material; and/or carry out any of the methods mentioned in this disclosure. Other system embodiments may be utilized.

The system generally includes a computing device 102 having a processor 104 that can execute code stored on a tangible computer-readable medium, such as a memory 106, to cause the computing device 102 to perform processes as described more fully herein. The computing device 102 may be any device that can process data and execute code that is a set of instructions to perform actions. Examples of the computing device 102 include a database server, a web server, desktop personal computer, a laptop personal computer, a server device, a handheld computing device, and a mobile device.

Examples of the processor 104 include a microprocessor, an application-specific integrated circuit (ASIC), a state machine, or other suitable processor. The processor 104 may include one processor or any number of processors. The processor 104 can access code stored in the memory 106 via a bus 108. The memory 106 may be any non-transitory computer-readable medium configured for tangibly embodying code and can include electronic, magnetic, or optical devices. Examples of the memory 106 include random access memory (RAM), read-only memory (ROM), a floppy disk, compact disc, digital video device, magnetic disk, an ASIC, a configured processor, flash drive, thumb drive, cloud memory capacity, or other storage device or capacity. The bus 108 may be any device capable of transferring data between components of the computing device 102. The bus 108 can include one device or multiple devices.

Instructions can be stored in the memory 106 as executable code. The instructions can include processor-specific instructions generated by a compiler and/or an interpreter from code written in any suitable computer-programming language, such as C, C++, C#, Visual Basic, Java, Python, Perl, JavaScript, and ActionScript. The instructions can include a database server application, such as engine 112. The executable code, when executed by the processor 104, can cause the computing device 102 to perform processes according to embodiments as explained in more detail in this disclosure.

Memory 106 can also include a datastore 114. The datastore 114 may be a relational database, a flat-file database, triplestore, cloud storage, or other data storage device or instrumentality. In other embodiments, the datastore 114 is separate from the computing device 102 but in communication with the computing device 102 through an input/output (I/O) interface 110.

The computing device 102 can share data with additional components through the I/O interface 110. The I/O interface 110 can include a USB port, eSATA port, Ethernet port, serial bus interface, parallel bus interface, wireless connection interface, or any suitable interface capable of allowing data transfers between the computing device and another component. The additional components can communicate with I/O interface 110 over a network 116. The network 116 can include the internet, an intranet, wide area network (WAN), local area network (LAN), virtual private network (VPN), or any suitable communications network that allows computing device 102 to communicate with other components. Network 116 may include one or more networks, and can operate using any desired protocols.

The additional components can include a database 118 and a user device 120. The database 118 may be remote from the computing device 102. In some embodiments, the database 118 can store various types of information as explained more fully below. The user device 120 can include a second computing device, such as a laptop or personal computer that is configured for processing commands to output a user interface to a display. In some embodiments, the user device 120 is a display device that is coupled to the computing device 102 directly instead of over the network 116. In some embodiments, any desired portion of the system can be connected to a CT scanner or other device capable of performing computed tomography, in order to interoperate with or form a portion of the scanner or device, or function as otherwise desired to carry out processes as described in this disclosure.

This exemplary system configuration is provided to illustrate configurations of certain embodiments. Other configurations and embodiments may of course be utilized.

b. Theory

The basis material decomposition theory which may be leveraged in certain embodiments of the invention, leads to the expression of the energy-dependent (E), mass attenuation coefficient for Material A, σ_{A}(E), as a linear combination of the mass attenuation coefficients for two basis materials, Material 1 and Material 2. In particular

ρ_{A}·σ_{A}(E)=ρ_{1A}·σ₁(E)+ρ_{2A}·σ₂(E) (Eq 1)

where ρ_{A} is the density of material A and ρ_{1A} and ρ_{2A} are abstract densities physically characteristic of Material A. σ_{A}(E) is physically constrained to be non-negative for all energies E in the energy range where the basis material decomposition theory applies. Thus it is apparent that either ρ_{1A} or ρ_{2A} may be negative, but not both. So while ρ_{1A} or ρ_{2A} have units of density, they do not necessarily represent physically realizable mixtures of basis materials 1 and 2. Each of the densities, ρ_{A}, ρ_{1A} and ρ_{2A} are effectively energy-independent at energies commonly used for whole-body CT imaging and so do not depend upon factors such as kVp. For convenience, the basis material composition for material A with density ρ_{A} is sometimes referred to using the tuple (ρ_{1A}, ρ_{2A}).

The CT value of Material A, CT_{A}, as measured on a particular CT scanner, can be written as a linear combination of the basis material composition densities, (ρ_{1A}, ρ_{2A}) if the response of the CT scanner to a change in density for each of the basis materials is accurately modeled as being proportional to the density of each basis material. In this common case, CT_{A} can be predicted using an equation of the form:

CT_{A}=β₁·ρ_{1A}+β₂·ρ_{2A}+C (Eq 2)

where β₁ and β₂ are characteristic of the CT scanner and the CT scan protocol, and C is a constant generally related to convention. Equation 2 shows that calibration of a CT scanner involves the determination of three parameters for a given CT scan protocol. The CT protocol parameters of particular interest in certain embodiments of the invention are parameters that affect the effective energy of the x-ray source. kVp is the primary protocol parameter under user-control that influences the effective energy of the x-ray source. Effective energy can also be influenced by changes in filtration of the x-ray source as well as by filtration of the x-ray source by attenuation due to the patient, phantoms and other materials within the field-of-view of the CT scanner.

CT scanners used for medical applications are generally calibrated in Hounsfield Units (HUs) where air is defined to have a CT value of −1000 HU and water is defined to have a CT value of 0 HU. When the HU scale is used, the constant in Equation 2 will typically have a value on the order of 1000. Additionally, if basis Material 1 is assumed to be water with a physical density of 1000 mg/cm3, then it can be seen that β1 for a properly calibrated CT scanner should have a value of 1 HU/(mg/cm3).

Regardless of convention with respect to scaling CT scanner measurements, the set of calibration parameters (β₁,β₂,C) can be estimated by imaging a phantom or other object containing a set of standards with known basis material compositions. In general CT values for a set of three standards must be obtained for a particular CT scan protocol to calibrate a particular scanner; although, the number of standards may be reduced if one or more of the three calibration parameters are known a priori by convention, as is the case when using Hounsfield Units, or other means.

### (i) Example

### The Aqueous K₂HPO₄ Bone Mineral Density Standard

Aqueous K₂HPO₄ was selected by Cann and Genant as the bone mineral standard for their pioneering work in the development of QCT for vertebral bone mineral density assessment. (C. Cann, H. Genant, “Precise measurement of vertebral mineral content using computed tomography,” J Comput Assist Tomogr 4, 493-500 (1980), incorporated herein by this reference). Their CT calibration scheme involves measuring CT values for a set of aqueous solutions containing varying and known amounts of K₂HPO₄. A linear fit to CT value versus K₂HPO₄ concentration then provides a mechanism for expressing average CT value in terms of an equivalent aqueous K₂HPO₄ concentration that would yield the same average CT value. The calibration slope derived with this approach neither defines the response of the CT scanner to a change in water density nor a change in K₂HPO₄ density, but rather describes calibration relative to a controlled variation in simultaneous changes in densities of both of these materials.

Supplementing the information derived from the Cann and Genant calibration approach with information regarding the physical density of aqueous K₂HPO₄ solutions of known concentration leads to an approach that does yield (β₁,β₂,C) defined above. Using published solution density information, it can be shown that at 20° C. the density of water in a sample of an aqueous solution of containing K₂HPO₄ density is:

ρ_{H2O}(ρ_{K2HPO4})=ρ_{H2O}(0)−0.1842·ρ_{K2HPO4} (Eq 3)

where ρ_{H2O}(0) is the density of pure water, 998.2 mg/cm3, at 20° C. Thus the basis material composition relative to the water and K₂HPO₄ basis set for an aqueous K₂HPO₄ solution with a K₂HPO₄ density of ρ_{K2HPO4} is (ρ_{H2O}(ρ_{K2HPO4}), ρ_{K2HPO4}). This information along with CT value measurements for the calibration standards can be used in Equation 2 to determine (β₁,β₂,C). It can be shown in the case of a CT scanner calibrated in HU's that β₁ has a value of 1.002 HU/(mg/cm3) for pure changes in water density at 20° C. and β₂ has a value that is equal to the slope derived using the conventional Cann and Genant calibration approach plus 0.1842 where β₂ characterizes of the CT scanner to pure changes in K₂HPO₄ density. The value of C in this case is −1000 HU. Given uncertainties in the purity of water and the temperature of the water used when calibrating a CT scanner, and the precision of typical CT scan measurements, it is convenient to assume β1 has a value of 1 HU/(mg/cm³) in practical applications.

It is also within the ambit of various embodiments of the invention to use human tissue as an internal control or basis material. For example, subcutaneous fat from a patient could be used as an internal patient control (assuming, for example that the DEQCT signal for subcutaneous fat variation is sufficiently small across subjects).

(ii) Basis Material Decomposition Methods

Imaging methods such as DXA and DEQCT can benefit from use of documented expressions derived from the theory of basis material decomposition to estimate equivalent densities of basis materials for unknown materials from images acquired at two different x-ray energies. A method for accomplishing this follows from Equation 2 when it is recognized that the basis material decomposition (ρ_{1A}, ρ_{2A}) is independent of kVp while the calibration of a CT scanner, (β₁,β₂), depends upon kVp.

According to this method, consider the measurement of the CT value for an unknown material at two different energies. For simplicity, assume the energies correspond to imaging at 80 kVp and 140 kVp. Two such measurements as denoted as CT₈₀ and CT₁₄₀, respectively. It is sought to derive estimates of the densities for two basis materials that accurately represent the mass attenuation coefficient for the unknown material. For simplicity, use is made of H₂O and K₂HPO₄ as the basis set, so that it is sought to derive an estimate for (ρ_{H2O}, ρ_{K2HPO4}) for the unknown material. To accomplish this requires knowledge of the CT-scanner-dependent response for each of the basis materials at both 80 kVp and 140 kVp. The symbol β with subscripts is used for material and energy to represent the scanner response terms. Finally, allowance is made for a scanner-dependent offset, C, that, in general, may depend upon kVp. Accordingly, the following set of equations is arrived at that must be solved to generate the basis material estimates:

$$( \begin{matrix}{CT}_{80} - {C}_{80} \\ {CT}_{140} - {C}_{140}\end{matrix} ) = ( \begin{matrix}{β}_{H 2 O , 80} & {β}_{K 2 HPO 4 , 80} \\ {β}_{H 2 O , 140} & {β}_{K 2 HPO 4 , 140}\end{matrix} ) \cdot ( \begin{matrix}{ρ}_{H 2 O} \\ {ρ}_{K 2 HPO 4}\end{matrix} ) \qquad ( Eq 4 )$$

Direct matrix inversion leads to the following solution for the basis material densities:

$$\begin{matrix}{ρ}_{H 2 O} = \frac{1}{D} \cdot [ {β}_{K 2 HPO 4 , 140} \cdot ( {CT}_{80} - {C}_{80} ) - {β}_{K 2 HPO 4 , 80} \cdot ( {CT}_{140} - {C}_{140} ) ] & ( Eq 5 ) \\ {ρ}_{K 2 HPO 4} = \frac{1}{D} \cdot [ {β}_{H 2 O , 80} \cdot ( {CT}_{140} - {C}_{140} ) - {β}_{H 2 O , 140} \cdot ( {CT}_{80} - {C}_{80} ) ] & ( Eq 6 ) \\ D = {β}_{H 2 O , 80} \cdot {β}_{K 2 HPO 4 , 140} - {β}_{H 2 O , 140} \cdot {β}_{K 2 HPO 4 , 80} & ( Eq 7 )\end{matrix}$$

Thus measuring the CT value for a particular sample at two different kVp settings for a calibrated CT scanner yields a set of two linear equations in two unknowns, (ρ_{1A}, ρ_{2A}), that can be solved using standard methods.

Equation 1 provides an alternative method for deriving basis material decompositions if the energy-dependent, mass attenuation coefficients for a pair of suitable basis materials and materials that are to be characterized using the basis material decomposition method are known or can be approximated to sufficient accuracy.

c. Processes

Certain processes according to certain embodiments of the invention can be carried out using certain embodiments of systems of the invention, with reference to some or all of the following:

(i) Basis Material Calibration

In accordance with theory addressed above, material calibration can include calibrating for one or more reference materials and two or more basis materials. First, expected energy dependent mass attenuation coefficients are calculated or provided. Second, basis material composition for the reference material is determined by finding a linear combination of basis material mass attenuation coefficients that is the best fit to the mass attenuation coefficient of the reference material.

(ii) Two Dimensional Scanner Calibration

One or more reference material CT pixel values are acquired using the CT scanner at a first, and if desired a second (and perhaps other) energy levels, which may be received by a system according to certain embodiments of the invention. One or more reference material CT pixel values may be extracted for one or more reference material regions of interest. Equations that incorporate, for one or more energy levels, this value, and expected reference material pixel value in terms of a linear combination of basis material densities and an offset, may be solved for the linear weights of the basis materials and an offset. These calibrated linear weights and offset can be used with CT pixel values acquired using the scanner operating at the relevant energy level to image an unknown material, in order to characterize basis material compositions for the unknown material and thereby characterize the unknown material.

(iii) Multiple Energy CT Patient Measurement

In the context of a patient, Multiple Energy CT image data is acquired at the relevant energy levels and segmented into one or more regions of interest (ROI's) within one or more anatomically, physiologically or functional areas of the patient's body. This step can occur at times different from the times at which basis material calibration occurs. For the relevant ROI, average pixel value may be measured, received by systems according to certain embodiments of the invention, and used in a set of equations that incorporate expected ROI pixel values in terms of unknown basis material composition for the ROI and the calibrated linear weights and offset. These equations may be solved for the ROI basis material composition, which can be used to characterize the area of the patient's body that corresponds to the ROI. The characterization is a two dimensional result (in terms of weights for the two basis materials) and can be presented as a point in two dimensional space. It may also be presented in two dimensional space relative to other materials of interest characterized in the space. It can also be presented as a point along a line or a curve defined relative to other materials of interest characterized in the space or a line or a curve otherwise defined in the space. It can also be presented as a projection onto a line or curve defined relative to other materials of interest characterized in the space or a line or curve otherwise defined in the space. Projection methods include projections onto a line or a curve from a particular direction or projection by finding the shortest distance from the point to the desired reference line or curve or other algorithm that uniquely maps a point in the 2D basis material space to a unique point on a reference line or curve.

Such processes and systems are useful for characterizing unknown material such as (among others) pancreatic tissue, bone marrow tissue, brain tissue, fat in muscle tissue, heart tissue, soft tissue, non-bone tissue, lung tissue, kidney stones, kidney tissue, and iron in liver tissue. They are also useful for distinguishing tissue, or portions of tissue from other portions of tissue, including, for example, fat in pancreatic tissue, red and yellow bone marrow tissue, white and grey matter brain tissue, fat in muscle tissue, healthy and necrotic heart tissue, healthy and nectrotic soft tissue, healthy and diseased non-bone tissue, normal and diseased lung tissue, kidney stones in kidney tissue, and iron in liver tissue.

(iv) Single Energy CT Patient Measurement

In the context of a patient, Single Energy CT image data is acquired at the relevant energy level and segmented into one or more regions of interest (ROI's) within one or more anatomically, physiologically or functional areas of the patient's body. This step can occur at times different from the times at which basis material calibration occurs. For the relevant ROI, average pixel value may be measured, received by systems according to certain embodiments of the invention, and used in an equation that incorporates an expected ROI pixel value in terms of unknown basis material composition for the ROI and the calibrated linear weights and offset. This equation defines a line in two dimensional space (in terms of weights for the two basis materials). Another line or curve in this two dimensional space, which may be known, is defined by a physiological condition such as an observed or modeled bone mineral density or liver fat content. The intersection of the line and the reference line or curve may be reported to characterize the area of the patient's body corresponding to the ROI. If the line and a reference curve do not intersect, then the minimum distance between the line and curve may be reported to characterize the area of the patient's body corresponding to the ROI. The concept of characterizing a patient-specific measurement line to a reference line or curve can be generalized to comparison of the patient-specific measurement to two or more such reference lines resulting in characterizing the patient measurement by two or more intersection points or other unique measures relative to the multiple reference lines or curves. One possible application of such an approach would be cross-calibration of measurements to different standards. In clinical practice today, for example, bone mineral density is sometimes reported relative to the aqueous K2HPO4 density standard while in other instances it is reported relative to a calcium hydroxyapatite standard. Both standards may be represented simultaneously in the 2D basis material space and a patient measurement may be expressed relative to either or both standards.

Such processes and systems are useful for characterizing unknown material such as (among others) pancreatic tissue, bone marrow tissue, brain tissue, fat in muscle tissue, heart tissue, soft tissue, non-bone tissue, lung tissue, kidney stones, kidney tissue, and iron in liver tissue. They are also useful for distinguishing tissue, or portions of tissue from other portions of tissue, including, for example, fat in pancreatic tissue, red and yellow bone marrow tissue, white and grey matter brain tissue, fat in muscle tissue, healthy and necrotic heart tissue, healthy and nectrotic soft tissue, healthy and diseased non-bone tissue, normal and diseased lung tissue, kidney stones in kidney tissue, and iron in liver tissue.

d. Exemplary Processes

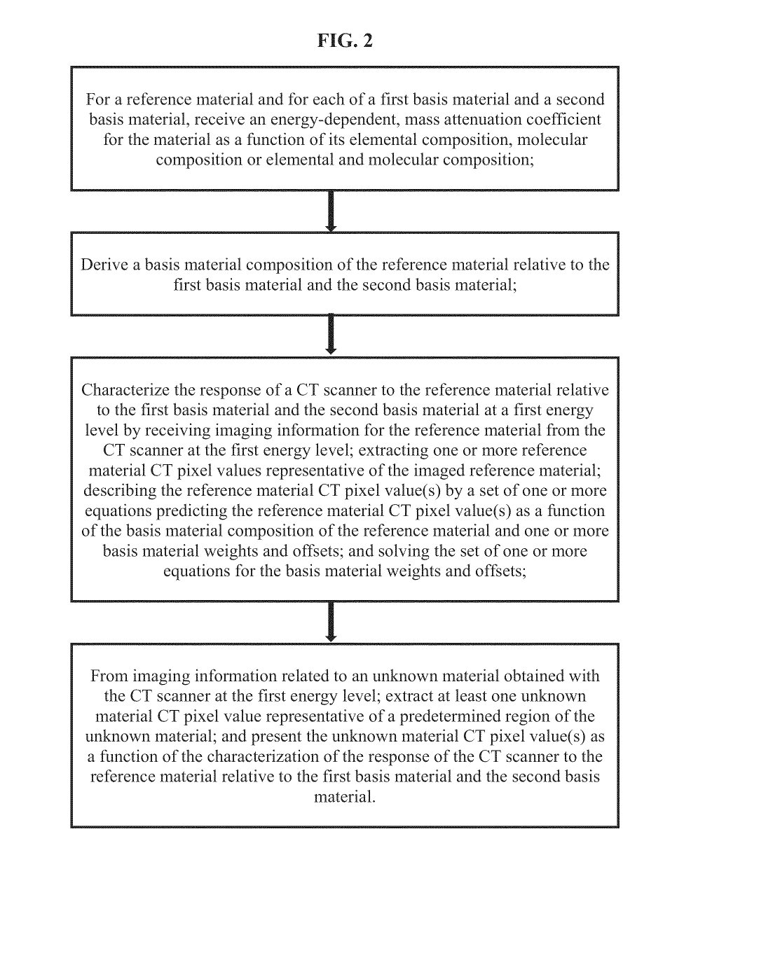

In some embodiments, the computer devices, processor devices, tangible medium embodiment code, and tangible computer readable media that includes program code can perform the following actions, as shown in FIG. 2:

1. For a reference material and for each of a first basis material and a second basis material, receiving an energy-dependent, mass attenuation coefficient for the material as a function of its elemental composition, molecular composition or elemental and molecular composition;
2. Deriving a basis material composition of the reference material relative to the first basis material and the second basis material;
3. Characterizing the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets;
4. From imaging information related to an unknown material received from the CT scanner at the first energy level; extracting at least one unknown material CT pixel value representative of a predetermined region of the unknown material; and presenting the at least one unknown material CT pixel value as a function of the characterization of the response of the CT scanner to the reference material relative to the first basis material and the second basis material.

The presentation can be in the form of graphical output such as on a monitor, or data that can be interpreted and used by other computing devices, processors, CT scanners, or other equipment.

In some embodiments, the computer devices, processor devices, tangible medium embodiment code, and tangible computer readable media that includes program code can also perform any or all of the following actions:

Using one or more CT pixel values to present an unknown material line in two dimensional basis material space, in order to characterize the unknown material.

Mapping the characterization of the response of the CT scanner to the first basis material and the second basis material to a single dimensional value relating to the reference material.

Mapping the representation of the unknown material CT pixel values as a function of the characterization of the response of the CT scanner to the first basis material and the second basis material to a single dimensional value relating to the reference material.

Comparing an unknown material line in two dimensional basis material space to a line for the reference material in two dimensional basis material space in order further to characterize the unknown material.

Receiving imaging information, carrying out methods described above, and presenting information for the unknown material at a first energy level and a second energy level.

Mapping the at least one unknown material CT pixel value back to a family of possible basis material compositions that are predicted to exhibit the same CT pixel value as the at least one unknown material CT pixel value.

Receiving imaging information for the unknown material can include receiving imaging information for a tissue, mixture, or substance.

Such processes and systems are useful for characterizing unknown material such as (among others) pancreatic tissue, bone marrow tissue, brain tissue, fat in muscle tissue, heart tissue, soft tissue, non-bone tissue, lung tissue, kidney stones, kidney tissue, and iron in liver tissue. They are also useful for distinguishing tissue, or portions of tissue from other portions of tissue, including, for example, fat in pancreatic tissue, red and yellow bone marrow tissue, white and grey matter brain tissue, fat in muscle tissue, healthy and necrotic heart tissue, healthy and nectrotic soft tissue, healthy and diseased non-bone tissue, normal and diseased lung tissue, kidney stones in kidney tissue, and iron in liver tissue.

In some embodiments, processes in step 3 in the embodiment stated above can occur at a time (and/or using a CT scanner) different than step 4 in that embodiment; thus, some or all of step 3, that is, characterizing the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets can occur at a time (and/or using a CT scanner) different from some or all of step 4, that is from imaging information related to an unknown material received from the CT scanner at the first energy level; extracting at least one unknown material CT pixel value representative of a predetermined region of the unknown material; and presenting the at least one unknown material CT pixel value as a function of the characterization of the response of the CT scanner to the reference material relative to the first basis material and the second basis material.

According to one embodiment, which may be carried out using a system such as shown in FIG. 1 described above and according to a process such as shown in FIG. 2, a reference material is provided in the form of CT calibration phantom marketed by Mindways Software, Austin, Tex., with known density and mass attenuation coefficient. Water and K₂HPO₄ are used as basis materials, and the XCOM database of National Institute of Standards and Technology is used for obtaining mass attenuation coefficients for the two basis materials (http//physics.nist.gov/PhysRefData/Xcom/html/xcom1.html). For purposes of characterizing the response of the CT scanner for the reference material (here, human fat where the scanner is operated at an energy level of 80 kVp) relative to the first basis material and the second basis material, a linear response model is used as follows:

CT Pixel Value=(Water Equiv Density)*A+(K₂HPO₄ Equiv Density)*B+C (Eq 8)

“Water Equivalent Density” and “K2HPO4 Equivalent Density” are the two numbers that describe the basis material composition for some material. A linear response model is not necessary, but appears to be sufficient for many practical applications of interest relative to CT imaging of human subjects. It is not necessary, but it appears to be sufficient to assume the coefficient “A” has a value of (1 HU/(mg/cm3)). This is essentially what would be expected for a CT scanner properly calibrated relative to the Hounsfield Unit scale. It is not necessary, but in many circumstances it is reasonable to assume the offset coefficient “C” has a value of (−1000 HU). As such, in their simplest form, certain embodiments of the invention can be reduced to imaging a single reference standard to gather sufficient information to solve a single equation in a single unknown (“B”). Multiple reference materials can be used leading to a set of equations in one or more unknowns that can be solved for the unknowns using various methods as long as the problem is not underdetermined (e.g., trying to use one reference material and one equation to extract 3 unknowns (e.g., “A”, “B” and “C”) is not going to lead to a useful representation of the CT scanner response in the context of this invention).

Thus, according to this embodiment, CT pixel value measurement may be represented in a pixel value space defined by a tool used for deriving basis material composition estimates from what amounts to physical principles rather than from, say, x-ray attenuation measurements. For example, assume a linear response model is suitable and that A, B and C in Eq 8 are known. In Eq 8, therefore, “CT Pixel Value” now refers to a measurement from a CT image, and “Water Equivalent Density” and “K₂HPO₄ Equivalent Density” are now unknowns. Solving Eq. 8 for “K₂HPO₄ Equivalent Density”:

(K₂HPO₄ Equiv Density)=((Water Equiv Density)*A+C−(CT Pixel Value))/B (Eq 9)

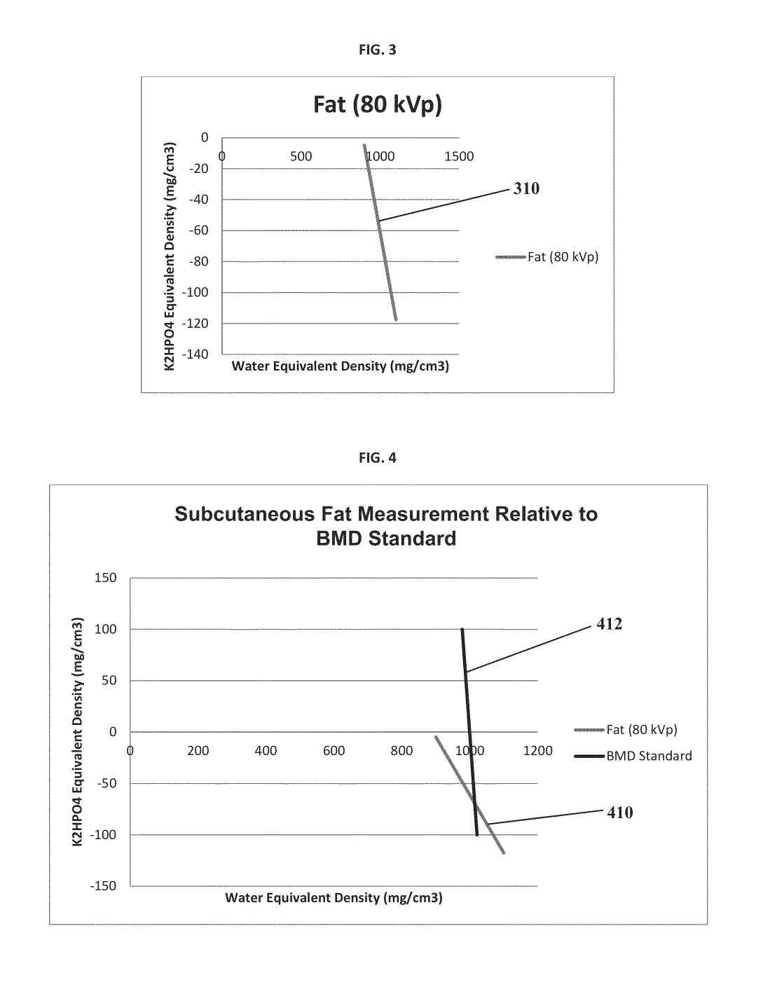

That is, given a single pixel value measurement from a CT scanner, a line can be defined in the basis material space. The “Fat (80 kVp)” graph shown in FIG. 3, which can be generated and presented by the system such as shown in FIG. 1, provides an example. It relates to a measurement from a CT scan from a region of subcutaneous fat at an energy level of 80 kVp. Whether or not the single value by itself is remarkable, FIG. 3 shows that the same information can be expressed or presented as a line (310). Additionally, the “Fat (80 kVp)” line can be presented if desired with one or more lines relating to reference materials. FIG. 4 shows “Fat (80 kVp)” line 410 with line 412 representing the reference material (here, a bone mineral density calibration standard or phantom marketed by Mindways Software, Austin, Tex.). This bone density calibration standard is based upon attenuation properties of aqueous solutions of K₂HPO₄.

FIG. 4 shows the line 410 in the basis material space relative to the bone mineral density standard line 412—both are calculated at 80 kVp based upon the measured response of the CT scanner at that energy level. The intersection point for these two lines is the equivalent bone mineral density of the fat measurement. Thus, the space of possible basis material compositions consistent with the measured CT value for the subcutaneous fat measurement can be compared with a composition consistent with the bone mineral density calibration standard. The bone mineral density at the intersection with the K₂HPO₄ line is −69.4 mg/cm3 which is the same as the K₂HPO₄ density at the intersection point.

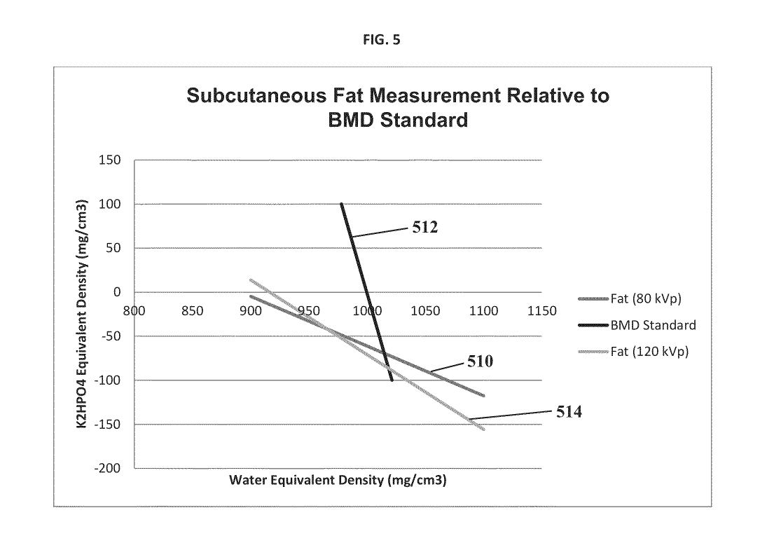

In another embodiment, a second CT scan is obtained of the subcutaneous fat at a second energy level of 120 kVp. The CT scanner response is different at 120 kVp, so the fat measurement line at 120 kVp is different. The bone mineral density standard is, however, a fixed standard in this space. FIG. 5, which can be generated and presented using systems such as shown in FIG. 1 and according to a process such as shown in FIG. 2, shows lines for the fat measurements at both 80 kVp and 120 kVp, together with the bone mineral density standard. The water equivalent density scale has been expanded from that scale as shown in FIG. 4. The fat measurement line at 80 kVp is shown as line 510; the bone mineral density standard line as 512, and the 120 kVp fat measurement line as 514. Note that the intersection of the Fat (120 kVp) measurement line 514 and the bone density standard line 512 is not the same as the point at which the Fat (80 kVp) measurement line 510 intersects the bone mineral density standard line 512. The equivalent bone mineral density of the 120 kVp subcutaneous fat measurement is about −87.5 mg/cm3. In fact the bone mineral density standard is not particularly convenient for characterizing fat because the bone mineral density estimate will change depending upon kVp and beam hardening (which affects the average energy of the x-rays hitting the CT scanner detector—beam hardening can be intentional, such as pre-filtration of the x-ray source or coincidental, such as degree of hardening due to patient size).

Note that the bone mineral density standard line did not change as a result of changing how the CT scanner is used. The density, for example, of an aqueous solution of 100 mg/cm3 of K₂HPO₄ does not change depending upon whether measurement occurs at 80 kVp or 120 kVp. It will always be that composition that is at the end of the black BMD calibration standard line which intersects the horizontal line corresponding to a K₂HPO₄ equivalent density of 100 mg/cm3. The unknown subcutaneous fat has the same physical attribute. Its density is not changed according to whether it is measured at 120 kVp or 80 kVp. The basis material composition for the subcutaneous fat that is consistent across the two measurements is at the intersection point of the 80 kVp and 120 kVp fat lines.

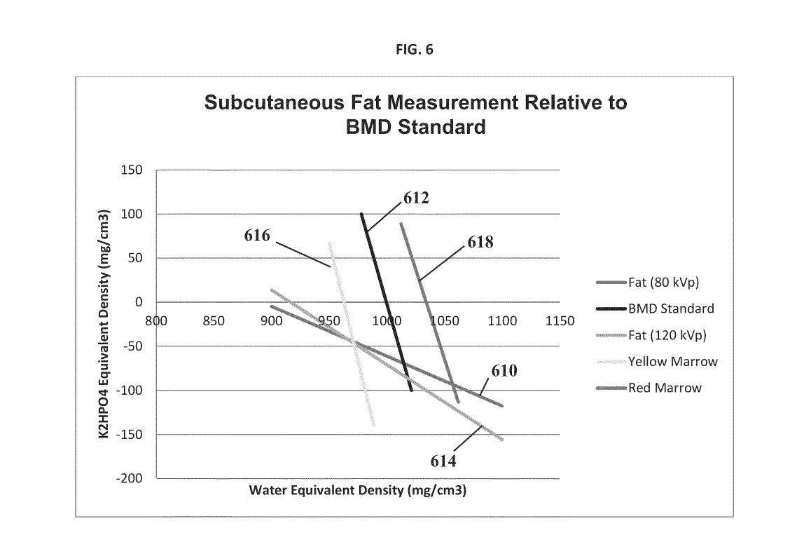

In another embodiment, presentation of results for which are reflected in FIG. 6, which can be generated and presented using systems such as shown in FIG. 1 and according to a process such as shown in FIG. 2, estimates of the bone mineral density calibration standard for two hypothetical scenarios can also be considered: (1) bone with a marrow space filled with pure yellow marrow and (2) bone with the marrow space filled with pure red marrow. Here, the fat 80 kVp line bears numeral 610; the bone mineral density line 612; the fat 120 kVp line 614; the yellow marrow line 616 and the red marrow line 618. These calculations are based upon atomic composition and density estimates from the literature, and are scanner independent and do not rely on a material that mimics bone. That is, there is no attempt to construct and measure with x-rays some yellow marrow mimic or some red marrow mimic. Instead, the lines for these two scenarios are constructed and presented based on mass attenuation coefficients obtained from the literature.

In another embodiment, the line generated and/or presented in the basis material space, which can be generated and presented using systems such as shown in FIG. 1 and according to a process such as shown in FIG. 2, can be compared to a standard reference line such as a bone mineral density line. The comparison can take the form of an intersection of the two lines, or shortest distance between the two lines. For example, the point could be estimated where “normal” liver sits in the basis material space. That point can be determined by experiment, such as the subcutaneous fat basis material composition point addressed above, or by calculation using known mass attenuation coefficients. Then, the closest distance between the normal liver reference point and the experimental measurement line can be considered. As another option, a line can be generated from the normal liver point based upon replacing liver with fat to calculate amount of fat based on where the experimental measurement line crosses the liver/fat line. As yet another option, the CT measurement can be dual energy measurements, in which case a basis material composition can be estimated for the unknown tissue. That estimate can allow measurements relative to the basis material composition rather than relative to the shortest distance between lines/points/curves. In similar or analogous fashion, two (or more) components or constituent materials of a region of interest or measurement volume may be characterized, such as according to the process shown in FIG. 2, in (for example and without limitation) fat in pancreatic tissue, yellow/red bone marrow tissue, white-matter/grey-matter brain tissue, fat in muscle tissue, healthy/necrotic heart tissue, any healthy/necrotic soft tissue, any healthy or normal/diseased or pathological tissue, normal/diseased lung tissue, calcified stones/kidney tissue, and iron in liver tissue. Another potential application of DEQCT quantification methods according to certain embodiments of the invention is characterization of “bright” deposits.

For example, there is provided according to one embodiment a process for characterization of kidney stones. The process can be conducted using systems such as shown in FIG. 1 and according to a process such as shown in FIG. 2. Kidney stones may be predominantly composed of uric acid or calcium. The origins of these different classes of kidney stones are different and may have implications regarding treatment. Deposition of uric acid crystals in joint spaces (gout) is also characteristically different than other forms of arthritis that lead to growth of calcium-based osteophytes. Uric acid and calcium have distinctly different basis material compositions.

While there are conventional proposed methods to characterize kidney stones, such methods are CT-scanner specific methods—the results are specific to a particular machine. By contrast, processes according to these embodiments of the invention are not CT-scanner specific, because they make use of the basis material space to reduce or eliminate scanner dependence. These embodiments thus help overcome problems arising from, among other things, the fact that HU scales for non-water-like materials can vary significantly across CT scanners.

The processes of these embodiments make use of the fact that in vivo kidney stones (and certain other structures) will be surrounded by water-like tissues. The kidney stones themselves will have appreciable amounts of calcium in the case of hydroxyapatite and oxalate stones, while cystine has sulfur and uric acid is nitrogen rich. Each of these materials has fairly different characteristics when viewed in the basis material space due to the significant difference in atomic numbers of these species. Uric acid to some extent looks like water (in the sense of being parallel to the water axis), but is actually slightly below the water axis reflecting the effective atomic number for uric acid being slightly less than water. Cystine has a pronounced positive “K2HPO4” character due to sulfur (atomic number 16—double that of oxygen). The calcium containing materials (Ca atomic number 20) are still higher, in the range of 2000 mg/cm3 to 3000 mg/cm3 range for K2HPO4 component.

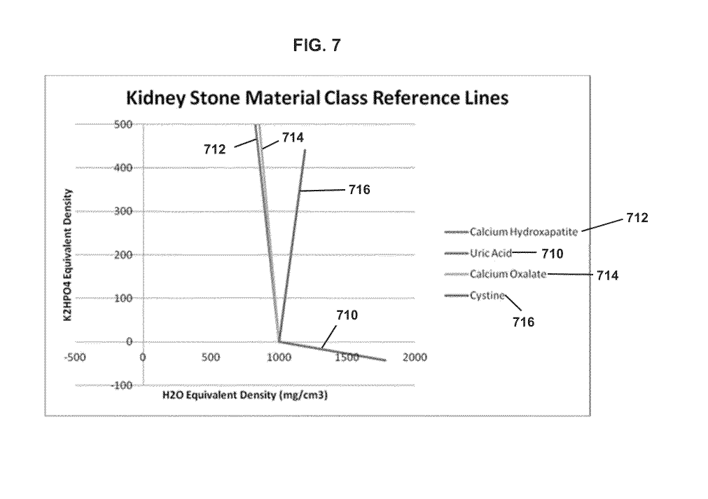

It can be difficult to obtain a CT image of just a kidney stone in vivo due to the spatial resolution limits of CT for reasonable clinical radiation doses. As such, what would be measured is some water-like tissue background along with a component characteristic of the composition of the kidney stone. In FIG. 7, which can be generated and presented using systems such as shown in FIG. 1 and according to a process such as shown in FIG. 2, and which shows lines that relate to various potential reference materials relevant to kidney stones, the intersection point of all of the reference lines is the “water” point. Some moving to the right (and downward) along the “uric acid” reference line 710 would represent a mixture that looks mostly like water with some of that water-like material replaced with uric acid crystals. Similarly, with a kidney stone rich in calcium, there will be displacement somewhere along the calcium hydroxyapatite and calcium oxalate lines (712 and 714 respectively) (and perhaps well above the scale shown in FIG. 7 depending upon how much of the sampled volume is filled with stone versus water-like tissue). Because of the proximity of the calcium hydroxyapatite and calcium oxalate lines 712 and 714, such processes may not be as useful for distinguishing between calcium oxalate and calcium hydroxyapatite kidney stones as between other materials. Cystine, shown with line 716, is not nearly as strong an absorber as calcium hydroxyapatite or calcium oxalate, so perhaps it can be distinguished both based upon intensity and proximity to the cystine reference line. In any event, it is possible to readily distinguish, using processes according to these embodiments, uric acid kidney stones from kidney stones rich in calcium salts and/or cysteine.

It is possible to prepare a measurement classifier that could include factors such as estimated stone size, signal strength (basically how far up the K2HPO4 axis a particular measurement falls for the size of the stone relative to the sampled volume), as well as proximity to one of the reference lines above to identify the nature of the kidney stone (calcium/cystine/uric acid). The method of using bisectors as described in A.N. Primak, et al., Noninvasive Differentiation of Uric Acid versus Non-Uric Acid Kidney Stones Using Dual-Energy CT, Academic Radiology, p. 1441, Vol. 14, No. 12, December 2007 (which is incorporated herein by this reference), is one logical starting point. Bisectors for calcium/cystine as well as cystine/uric acid should be examined as well.

In general, some embodiments relate to the projection of a single value received from a CT scan back into a two dimensional space, which single value defines a line in the two dimensional (basis material) space. The two dimensional space is very rich because, among other things, various theoretical and experimental results in the two dimensional space can be generated and explored in a controlled (calibrated) manner without significant consideration for the source of the experimental data (i.e., what CT scanner was used and in exactly what mode it was used). Moreover, the one-dimensional to two dimensional mapping can be reversed: Once something interesting is apparent in the device-independent two dimensional space, it can be transformed back into one dimension by applying the reverse transform derived for a specific CT scanner used in a particular manner. Such a transformation can be valuable, for instance, where there are various calibration problems that occur because by pixel values observed on a particular CT scanner depend upon the CT scanner and how it is used. One such example is above, where the subcutaneous fat example used above resulted in estimated CT values of −108.4 HU at 80 kVp and −83.7 HU at 120 kVp.

Another embodiment of the invention involves comparing fat measurements made with Magnetic Resonance Spectroscopy (MRS) and DEQCT. MRS is an accepted method for in vivo quantification of marrow fat. The inventor has found that marrow fat as measured by DEQCT can accurately predict MRS fat measurements.

Several issues immediately arise when considering the correlation of DEQCT and MRS derived estimates of marrow fat. MRS results are presented as a fat ratio. In particular, the ratio of (fat signal) to (fat signal+water signal) is reported with MRS when quantifying marrow fat. This ratio is expected to approach unity if the marrow space is dominated by the presence of yellow marrow (fatty marrow) and it is expect to approach zero if there is little fat in the marrow space (as might be the case for mostly red marrow). So this is neither an absolute quantification of the amount of water present nor an absolute quantification of the amount of fat present, and the interpretation of the measured ratio is confounded by the presence of other materials in a tissue environment as highly diverse as cancellous bone. That is, there may be molecular species present in the bone (and bone marrow) environment that are neither accurately described as “fat” or “water” that might contaminate either or both “signals” and their ratio.

Compare the above MRS scenario to what is measured by DEQCT. There is no molecular level selectivity with DEQCT. Any atomic species present that can scatter x-rays (which means all atomic species present) in the sample volume will contribute to the measured DEQCT signal. Looking at a ratio such as the amount of fat contributing to the DEQCT signal versus the amount of (fat+water) contributing to the DEQCT signal is an ill-defined concept. How is the signal from calcium, collagen, hemoglobin and other materials present in cancellous bone removed from the signal so that the desired MRS-equivalent ratio can be predicted? This is a different scenario than, say, contemplating measuring the amount of fat present in liver tissue in cases where one can reasonably assume that only “fat” and “normal liver” tissue are present in a sample that is being quantified. Again, bone presents a very diverse environment that is simply not easy to describe in its substantial entirety by the amounts of two constituents.

One approach to this marrow fat problem in the DEQCT space is to consider projecting the DEQCT measurements onto a line that passes through the basis material composition expected for water (e.g., as derived using the XCOM data) as well as the basis material composition expected for pure yellow marrow (e.g., as derived by using the XCOM data). That projection of DEQCT results onto such a line can provide a simple means for mapping DEQCT measurements to the MRS measurement space is not obvious. It is possible, for example, to consider other lines such as projection onto a line perpendicular to the bone density reference standard which nominally characterizes the expected change in signal due to the displacement of water from a hydrated cadaveric bone sample by the presence of mineralized bone. By projecting measurements onto this orthogonal line, it can be possible to subtract out the “mineralized collagen” component of the DEQCT bone signal. Another option may be to project the DEQCT measurements onto lines of constant BMD for a single energy QCT measurement. These lines in the basis material space represent mixtures of atomic constituents that can lead to the same BMD estimate for single energy QCT at a particular energy even though they had different relative amounts of bone and marrow and marrow composition. It is possible, for example, to contemplate the replacement of some red marrow with yellow marrow (which by itself would decrease the estimate bone mineral density) while adding some additional mineralized bone to the characterized volume such that the overall BMD remained constant.

What can separate consideration of these various lines that may be interesting projection axes in the basis material space is if interest in them is not driven by predicting how a signal might change as a result of, for example, replacing some “normal liver” tissue with some “fat”, but rather by trying to find a way to quantify a DEQCT measurement in a way that excludes or significantly reduces the impact of some “uninteresting” part of a measurement (e.g., mineralized collagen) from the part that might be “interesting” (e.g., some measure of the relative amounts of water and fat in the marrow space). In this latter scenario, one does not have a detailed model of what's going on in bone, such that use of XCOM would allow ready prediction of an outcome and quantification of some signal relative to this predicted outcome. Rather, there is instead a somewhat ill-defined MRS measurement with some complex DEQCT measurements. It is not obvious that one can accurately predict the MRS results from the DEQCT measurements.

One approach to this issue is to pair MRS and DEQCT measurements. One can ask the general question about the line that DEQCT measurements could be projected on that would maximize the correlation between the projected DEQCT measurements and the MRS measurements. One can restrict this search to a search of all possible lines that go through the expected basis material composition for water since “water” is an important component of the MRS signal. An extension of this approach is to generalize the search to all possible lines in the basis material plane. However, that is actually a more complex problem (because of degenerate solutions associated with the fact that whatever that “minimum” line is (and it may actually be more than one unique line) could be described relative to any point along the lines—all such descriptions would give the same value for the maximum correlation coefficient).

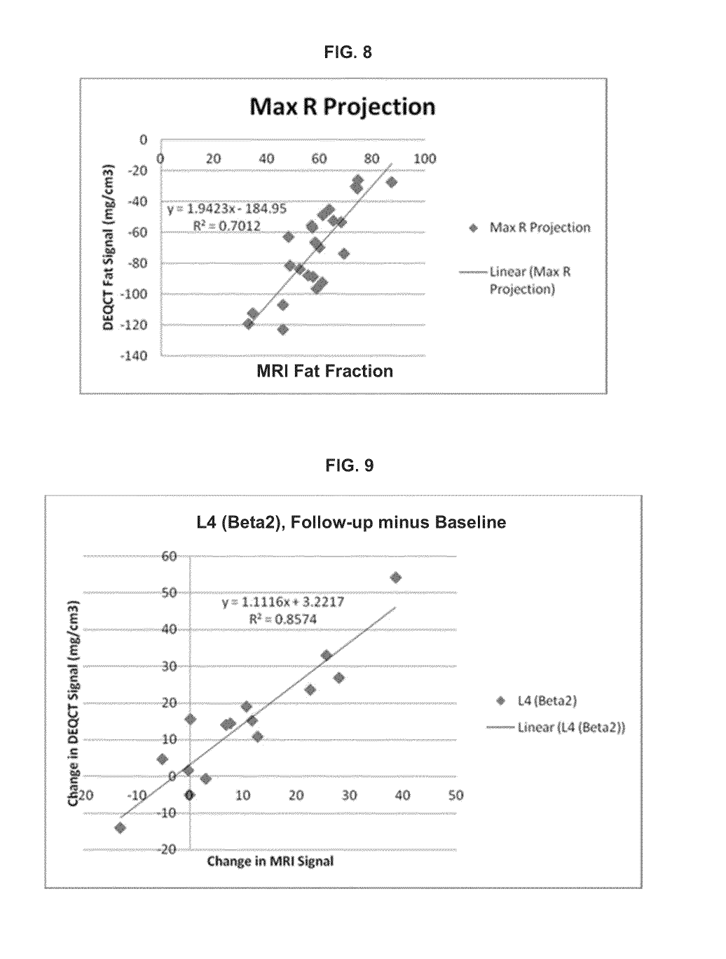

The results of this exercise, which can be conducted using systems such as shown in FIG. 1 and according to a process such as shown in FIG. 2, are summarized in FIGS. 8 and 9. They provide a potential example of possible utility of this approach to quantifying the results. FIG. 8 shows pair MR and DEQCT fat measurements. The square of the correlation coefficient (R) in this case is about 0.7 which implies R is about 0.84, which is a relatively strong correlation.

FIG. 9 shows the change in the fat signal as measured by both methods. As mentioned in the comments above, both the DEQCT and MRS measurements are potentially contaminated by materials unrelated to those that are really the subject of quantification. Subtracting the baseline measurement from a follow-up measurement might subtract out a substantial portion of the signal contamination if the degree of contamination does not change appreciably between baseline and follow-up. When one considers the difference in signals, it is apparent that R in this case for this data is about 0.93 (R2 of about 0.86). As such, it may be that DEQCT predicts the change in MRS fat signal as accurately as or more accurately than it does in predicting the absolute MRS fat signal.

Coincidentally, it so happens that the projection line that maximizes R goes through the predicted water basis material composition (by construction) and it comes very close to going through the pure yellow marrow line. That is, projecting the DEQCT results on the line passing through yellow marrow and water (one of the options discussed above) seems to do a good job of isolating the “fat” and “water” components measured by MRS.

e. General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure subject matter that may be claimed.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A method for execution by a computing device that comprises:
a. For a reference material and for each of a first basis material and a second basis material, receiving in a computing device an energy-dependent, mass attenuation coefficient for the material as a function of its elemental composition, molecular composition or elemental and molecular composition;
b. Deriving by the computing device a basis material composition of the reference material relative to the first basis material and the second basis material;
c. Characterizing by the computing device the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets;
d. From imaging information related to an unknown material received from the CT scanner at the first energy level; extracting by the computing device at least one unknown material CT pixel value representative of a predetermined region of the unknown material; and presenting by the computing device the at least one unknown material CT pixel value as a function of the characterization of the response of the CT scanner to the reference material relative to the first basis material and the second basis material.

2. A method according to claim 1 further comprising using one or more CT pixel values to present an unknown material line in two dimensional basis material space, in order to characterize the unknown material.

3. A method according to claim 1 further comprising mapping a characterization of the response of the CT scanner to the first basis material and the second basis material to a single dimensional value relating to the reference material.

4. A method according to claim 1 further comprising mapping the at least one unknown material CT pixel value as a function of the characterization of the response of the CT scanner to the first basis material and the second basis material to a single dimensional value relating to the reference material.

5. A method according to claim 1 further comprising comparing an unknown material line in two dimensional basis material space to a line for the reference material in two dimensional basis material space in order further to characterize the unknown material.

6. A method according to claim 1 further comprising receiving imaging information and presenting information for the unknown material at a first energy level and a second energy level.

7. A method according to claim 1 further comprising mapping the at least one unknown material CT pixel value back to a predetermined family of possible basis material compositions that exhibit the same CT pixel value as the at least one unknown material CT pixel value.

8. A method according to claim 1 wherein receiving imaging information for the unknown material includes receiving imaging information for a tissue, a mixture, or a substance.

9. A method according to claim 1 wherein presenting by the computing device the at least one unknown material CT pixel value as a function of the characterization of the response of the CT scanner to the reference material relative to the first basis material and the second basis material includes presenting graphically.

10. A method according to claim 1 wherein the unknown material is selected from the group consisting of: pancreatic tissue, bone marrow tissue, brain tissue, fat in muscle tissue, heart tissue, soft tissue, non-bone tissue, lung tissue, kidney stones, kidney tissue, and iron in liver tissue.

11. A method according to claim 1 further comprising distinguishing tissue selected from the group consisting of: fat in pancreatic tissue, red and yellow bone marrow tissue, white and grey matter brain tissue, fat in muscle tissue, healthy and necrotic heart tissue, healthy and nectrotic soft tissue, healthy and diseased non-bone tissue, normal and diseased lung tissue, kidney stones in kidney tissue, and iron in liver tissue.

12. A system, comprising:
A processor device; and
A tangible medium embodying code that is executable by the processor device to cause the system to:
a. Receive, for a reference material and for each of a first basis material and a second basis material, an energy-dependent, mass attenuation coefficient for the material as a function of its elemental composition, molecular composition or elemental and molecular composition;
b. Derive a basis material composition of the reference material relative to the first basis material and the second basis material;
c. Characterize the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets;
d. From imaging information related to an unknown material received from the CT scanner at the first energy level, extract at least one unknown material CT pixel value representative of a predetermined region of the unknown material; and present the at least one unknown material CT pixel value as a function of the characterization of the response of the CT scanner to the reference material relative to the first basis material and the second basis material.

13. A system according to claim 12 wherein the code is capable of causing the system to use one or more CT pixel values to present an unknown material line in two dimensional basis material space, in order to characterize the unknown material.

14. A system according to claim 12 wherein the code is capable of causing the system to map a characterization of the response of the CT scanner to the first basis material and the second basis material to a single dimensional value relating to the reference material.

15. A system according to claim 12 wherein the code is capable of causing the system to map the at least one unknown material CT pixel value as a function of the characterization of the response of the CT scanner to the first basis material and the second basis material to a single dimensional value relating to the reference material.

16. A system according to claim 12 wherein the code is capable of causing the system to compare an unknown material line in two dimensional basis material space to a line for the reference material in two dimensional basis material space in order further to characterize the unknown material.

17. A system according to claim 12 wherein the code is capable of permitting the system to receive imaging information and present information for the unknown material at a first energy level and a second energy level.

18. A system according to claim 12 wherein the code is capable of causing the system to map the at least one unknown material CT pixel value back to a predetermined family of possible basis material compositions that exhibit the same CT pixel value as the at least one unknown material CT pixel value.

19. A method according to claim 12 wherein the code is configured to cause the system to characterize an unknown material selected from the group consisting of: pancreatic tissue, bone marrow tissue, brain tissue, fat in muscle tissue, heart tissue, soft tissue, non-bone tissue, lung tissue, kidney stones, kidney tissue, and iron in liver tissue.

20. A method according to claim 12 further comprising code that is executable by the processor device to cause the system to distinguish tissue selected from the group consisting of: fat in pancreatic tissue, red and yellow bone marrow tissue, white and grey matter brain tissue, fat in muscle tissue, healthy and necrotic heart tissue, healthy and nectrotic soft tissue, healthy and diseased non-bone tissue, normal and diseased lung tissue, kidney stones in kidney tissue, and iron in liver tissue.

21. A tangible computer readable medium that includes program code that is executable by a processor to perform actions, the program code comprising:
a. Code for causing the processor to receive, for a reference material and for each of a first basis material and a second basis material, an energy-dependent, mass attenuation coefficient for the material as a function of its elemental composition, molecular composition or elemental and molecular composition;
b. Code for causing the processor to derive a basis material composition of the reference material relative to the first basis material and the second basis material;
c. Code for causing the processor to characterize the response of a CT scanner to the reference material relative to the first basis material and the second basis material at a first energy level by receiving imaging information for the reference material from the CT scanner at the first energy level; extracting at least one reference material CT pixel value representative of the imaged reference material; describing the at least one reference material CT pixel value by a set of one or more equations predicting the at least one reference material CT pixel value as a function of the basis material composition of the reference material and one or more basis material weights and offsets; and solving the set of one or more equations for the basis material weights and offsets;
d. Code for causing the processor to do the following: From imaging information related to an unknown material received from the CT scanner at the first energy level; extract at least one unknown material CT pixel value representative of a predetermined region of the unknown material; and present the at least one unknown material CT pixel value as a function of the characterization of the response of the CT scanner to the reference material relative to the first basis material and the second basis material.

22. A tangible computer readable medium according to claim 21 wherein the program code includes code for causing the system to use one or more CT pixel values to present an unknown material line in two dimensional basis material space, in order to characterize the unknown material.

23. A tangible computer readable medium according to claim 21 wherein the program code includes code for causing the system to map a characterization of the response of the CT scanner to the first basis material and the second basis material to a single dimensional value relating to the reference material.

24. A tangible computer readable medium according to claim 21 wherein the program code includes code for permitting the system to receive imaging information and present information for the unknown material at a first energy level and a second energy level.

25. A method according to claim 21 wherein the code is configured to cause the system to characterize an unknown material selected from the group consisting of: pancreatic tissue, bone marrow tissue, brain tissue, fat in muscle tissue, heart tissue, soft tissue, non-bone tissue, lung tissue, kidney stones, kidney tissue, and iron in liver tissue.

26. A method according to claim 21 further comprising code that is executable by the processor to cause the system to distinguish tissue selected from the group consisting of: fat in pancreatic tissue, red and yellow bone marrow tissue, white and grey matter brain tissue, fat in muscle tissue, healthy and necrotic heart tissue, healthy and nectrotic soft tissue, healthy and diseased non-bone tissue, normal and diseased lung tissue, kidney stones in kidney tissue, and iron in liver tissue.
